(19) United States
(12) Patent Application Publication
(10) Pub. No.: US 2025/0010635 A1
(43) Pub. Date: Jan. 9, 2025

(54) IMAGE FORMING APPARATUS

(71) Applicant: KYOCERA Document Solutions Inc., Osaka (JP)

(72) Inventors: Masato Usui, Osaka (JP); Hiroomi Nakatsuji, Osaka (JP); Naoko Kawashima, Osaka (JP); Jun Nakano, Osaka (JP)

(21) Appl. No.: 18/758,856

(22) Filed: Jun. 28, 2024

(30) Foreign Application Priority Data
Jul. 3, 2023 (JP) 2023-109186

(51) Int. Cl. B41J 2/21

(52) U.S. Cl. CPC B41J 2/2142; B41J 2/2135; B41J 2/2139; B41J 2/2146

(57) ABSTRACT

An image forming apparatus includes a recording head, a control unit, an ejection malfunction nozzle detecting unit, and a correction processing unit. The recording head is configured to eject ink corresponding to an image to be printed, using arranged nozzles. The control unit is configured to determine nozzles corresponding to the image to be printed and cause the recording head to eject ink from the nozzles. The ejection malfunction nozzle detecting unit is configured to perform an ejection malfunction test and thereby detect an ejection malfunction nozzle among the nozzles. The correction processing unit is configured to perform a correction process corresponding to the detected ejection malfunction nozzle.

### CROSS-REFERENCE TO RELATED APPLICATIONS

This application relates to and claims priority rights from Japanese Patent Application No. 2023-109186, filed on Jul. 3, 2023, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus prints a test pattern on a print sheet using a recording head; on the basis of an image of the printed test pattern, detects an ejection malfunction nozzle that can not properly eject ink among nozzles that eject ink in the recording head; and as a correction process, increases an ink amount of an adjacent dot. Further, the image forming apparatus periodically tests the nozzles and sets the malfunction nozzle to be unavailable; if it is determined that there is not malfunction on the unavailable malfunction nozzle in a test immediately thereafter, then this nozzle is returned to be available; but if in the predetermined number of times of the tests it is determined that there is malfunction on the unavailable malfunction nozzle, then the nozzles is continuously set to be unavailable. Consequently, even if misdetection of a malfunction nozzle occurs, the misdetection is canceled in a test immediately thereafter.

However, even if a malfunction nozzle is correctly detected, foreign substance or dirt attached on the nozzle may be removed over time due to printing actions thereafter.

Even though the aforementioned apparatus can cancel misdetection of a malfunction nozzle in a test immediately thereafter, if malfunction occurs on a nozzle due to a cause that will be removed over time due to printing actions thereafter, the nozzle is still determined as a malfunction nozzle in the test immediately thereafter; and therefore, even if the causes of the malfunction is removed thereafter, this nozzle is continuously set to be unavailable.

### SUMMARY

An image forming apparatus according to an aspect of the present disclosure includes a recording head, a control unit, an ejection malfunction nozzle detecting unit, and a correction processing unit. The recording head is configured to eject ink corresponding to an image to be printed, using arranged nozzles. The control unit is configured to determine nozzles corresponding to the image to be printed and cause the recording head to eject ink from the nozzles. The ejection malfunction nozzle detecting unit is configured to perform an ejection malfunction test and thereby detect an ejection malfunction nozzle among the nozzles. The correction processing unit is configured to perform a correction process corresponding to the detected ejection malfunction nozzle. Further, in continuous printing, the ejection malfunction nozzle detecting unit performs the ejection malfunction test without the correction process every printing of a predetermined number of pages, and renews the ejection malfunction nozzle for which the correction process is performed, on the basis of a result of the ejection malfunction test.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a block diagram that indicates an electronic configuration of the image forming apparatus 10 in the embodiment according to the present disclosure;

FIG. 4 shows a flowchart that explains a behavior in continuous printing of the image forming apparatus shown in FIGS. 1 to 3; and

FIG. 5 shows a diagram that explains the number of correction target nozzles in continuous printing of 50,000 pages in the image forming apparatus in an embodiment according to the present disclosure.

### DETAILED DESCRIPTION

Hereinafter, an embodiment according to an aspect of the present disclosure will be explained with reference to drawings.

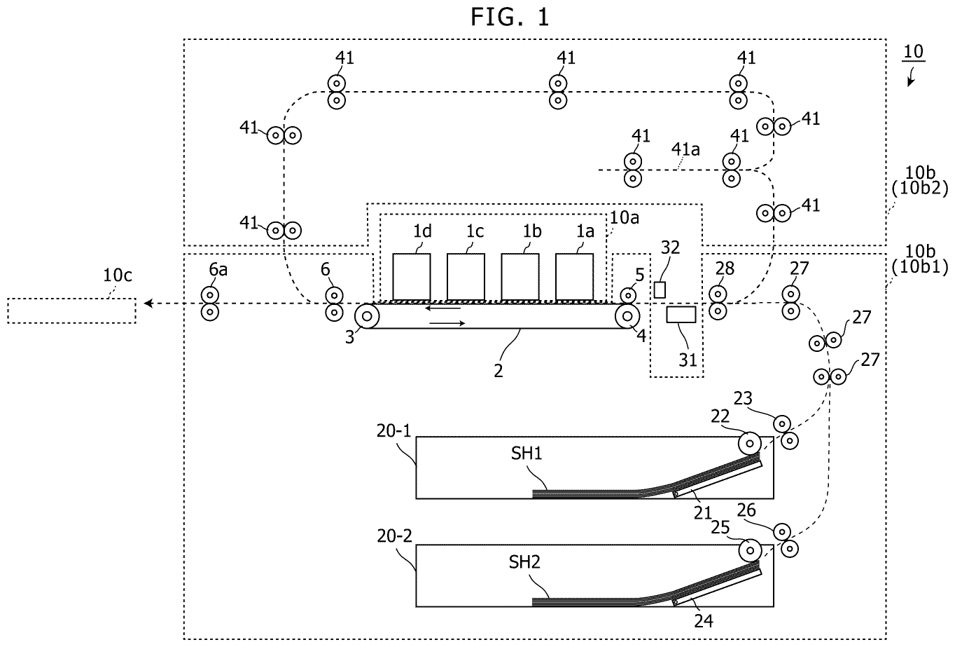

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type head units 1a to 1d corresponding to four ink colors: Cyan, Magenta, Yellow, and Black.

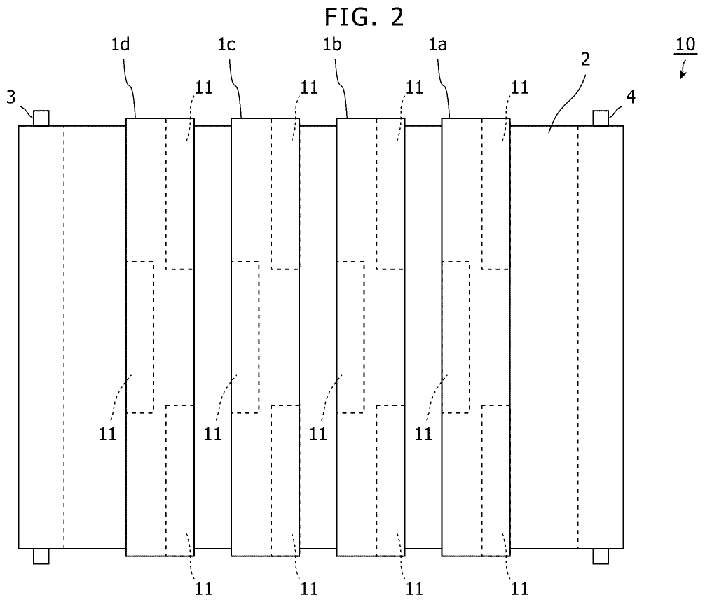

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11. The head unit 11 of the inkjet recording unit 1a, 1b, 1c or 1d includes 2-dimensionally arranged nozzles corresponding to ejection positions arranged in a primary scanning direction, and ejects ink corresponding to the image to be printed using the nozzles.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

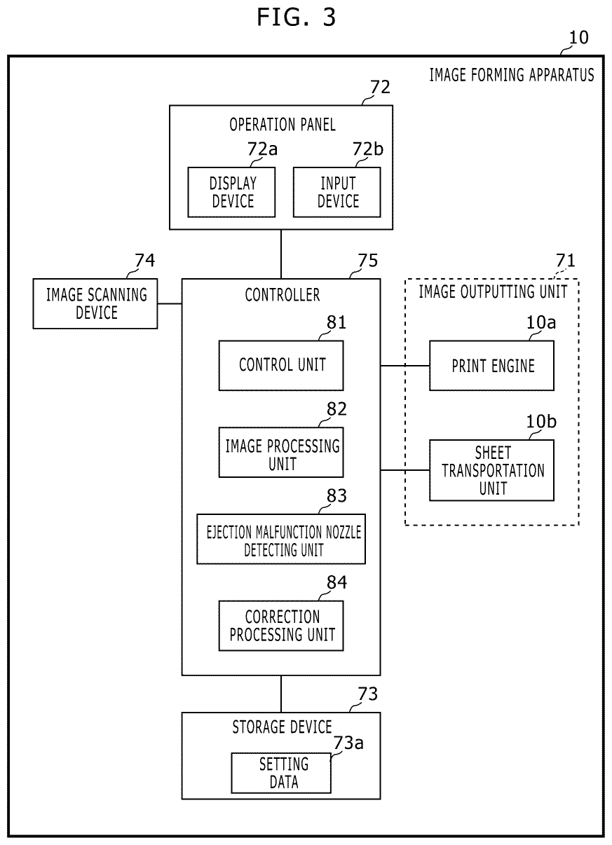

FIG. 3 shows a block diagram that indicates an electronic configuration of the image forming apparatus 10 in the embodiment according to the present disclosure. As shown in FIG. 3, the image forming apparatus 10 includes not only an image outputting unit 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, an ejection malfunction nozzle detecting unit 83, and a correction processing unit 84.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. The image processing unit 82 performs a predetermined image process such as RIP (Raster Image Processing), color conversion, halftoning and/or the like for image data of a printing image.

Specifically, the control unit 81 causes the print engine 10a to print a user document image based on printing image data specified by a user.

Further, in this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process. Specifically, in the automatic centering function, the control unit 81 changes a depicting position of the image to be printed, in a primary scanning direction by a difference between a reference center position of the print engine 10a and the actual sheet center position. In this embodiment, because the nozzles of the recording heads 1a to 1d do not move, a nozzle corresponding to each pixel in the image to be printed is changed correspondingly to the depicting position of the image to be printed.

As mentioned, the control unit 81 determines nozzles corresponding to the image to be printed (i.e. a nozzle corresponding to each pixel) (here, correspondingly to a position of a print sheet), and causes the recording heads 1a to 1d to eject ink from the determined nozzles.

The ejection malfunction nozzle detecting unit 83 performs an ejection malfunction test of the nozzles in the recording heads 1a to 1d, and thereby detects an ejection malfunction nozzle among the nozzles in the recording heads 1a and 1d. The ejection malfunction nozzle detecting unit 83 (a) prints a test pattern on a print sheet using the recording head 1a, 1b, 1c or 1d, and (b) detects an ejection malfunction nozzle on the basis of a density distribution of a scanned image of the test pattern. Further, the ejection malfunction nozzle detecting unit 83 stores as setting data 73a into the storage device 73 ejection malfunction nozzle data (nozzle number or the like) that indicates the detected ejection malfunction nozzle.

The test pattern is an existent one and for example a band-shaped image with a single density or an image including a thin line corresponding to each nozzle.

Further, a scanned image of the aforementioned test pattern is acquired for example, as RGB image data using the line sensor 31 or the image scanning device 74. If the line sensor 31 scans an image of the test pattern, the print sheet on which the test pattern has been printed by the print engine 10a is transported to a position of the line sensor 31 using the circulation transportation unit 10b2.

Further, a resolution of the aforementioned scanned image (i.e. scan resolution) is lower than a resolution of the test pattern printed on the print sheet using the recording head 1a, 1b, 1c or 1d (i.e. print resolution). For example, the resolution of the aforementioned scanned image is set to be equal to or less than one quarter of the print resolution. For example, when the print resolution is 1200 dpi, the resolution of the aforementioned scanned image is 300 dpi.

When ejection malfunction occurs on a nozzle, a density defect appears in the test pattern. Therefore, in a density distribution of the scanned image, a density reduction appears at a density defect position in the test pattern. However, the density reduction does not have a peak shape but gently changes when the resolution of the aforementioned scanned image is lower than the print resolution. Therefore, the ejection malfunction nozzle detecting unit 83 determines a pixel having a smallest density at the density reduction of the density distribution of the aforementioned scanned image and determines an ejection malfunction nozzle among nozzles the pixel on the basis of a shape of the density reduction of the density distribution of the aforementioned scanned image.

The correction processing unit 84 performs a correction process (here, as a hardware process) corresponding to a correction target nozzle for an image to be printed. In this correction process, for example, image data (pixel value) of a pixel corresponding to an ejection malfunction nozzle is corrected to a value of non ink ejection, and image data (pixel value) of a pixel adjacent to the ejection malfunction nozzle is corrected so as to increase a density of this pixel.

Further, in continuous printing (i.e. a print job for continuously printing plural pages), the ejection malfunction nozzle detecting unit 83 performs the ejection malfunction test without the correction process (i.e. prints a test pattern without the correction process) every printing of a predetermined number of pages, and renews the ejection malfunction nozzle for which the correction process should be performed, on the basis of a result of the ejection malfunction test.

For example, in continuous printing of 50,000 pages, the ejection malfunction test is performed every printing of 10,000 pages. The aforementioned predetermined number of pages as an interval of the ejection malfunction tests may be a fixed value and can be set by a user.

In the ejection malfunction test performed every printing of a predetermined number of pages, on the basis of a result of the current ejection malfunction test, the ejection malfunction nozzle detecting unit 83 sets both of the ejection malfunction nozzle for which the correction process is performed and the ejection malfunction nozzle for which the correction process is not performed.

In this embodiment, the number of the ejection malfunction nozzle for which the correction process is performed are limited to be equal to or less than a predetermined upperlimit number (e.g. 100). This upperlimit number is a limit number of ejection malfunction nozzles for which the correction process can be performed in time from determination of a nozzle for each pixel in an image to be printed to ejection of ink from the nozzle. (a) If the number of the ejection malfunction nozzles detected in the current ejection malfunction test does not exceed the predetermined upperlimit number, the correction processing unit 83 may set both of the ejection malfunction nozzle for which the correction process is performed and the ejection malfunction nozzle for which the correction process is not performed, on the basis of a result of the current ejection malfunction test; and (b) if the number of the ejection malfunction nozzles detected in the current ejection malfunction test exceeds the predetermined upperlimit number, the correction processing unit 83 may set the ejection malfunction nozzle for which the correction process is performed, on the basis of a result of the previous ejection malfunction test and a result of the current ejection malfunction test.

In such a case, for example, a result of the ejection malfunction test (nozzle numbers of ejection malfunction nozzles, or the like) is stored as history data or the like into the storage device 73; and if the number of ejection malfunction nozzles in the current ejection malfunction test exceeds the predetermined upperlimit number, then on the basis of the history data, a nozzle detected as an ejection malfunction nozzle a larger number of times in the previous tests of the predetermined number of times is more preferentially selected as the ejection malfunction nozzle for which the correction process is performed.

The following part explains a behavior of the image forming apparatus 10.

### (a) Setting of a Nozzle as a Target of the Correction Process

The ejection malfunction nozzle detecting unit 83 performs an ejection malfunction test at a predetermined timing. In the ejection malfunction test, the ejection malfunction nozzle detecting unit 83 firstly, using the control unit 81, causes the image outputting unit 71 to print the aforementioned test pattern with a predetermined print resolution on a print sheet, and acquires with a predetermined scan resolution a scanned image (RGB image data, grayscale image data or the like) of the test pattern printed on the print sheet.

Further, the ejection malfunction nozzle detecting unit 83 detects ejection malfunction nozzles as mentioned from a density distribution in a primary scanning direction of the scanned image of the test pattern, sets correction target nozzles as the ejection malfunction nozzles, and stores the setting data 73a that indicates the correction target nozzles (identification information such as nozzle numbers) into the storage device 73. Here, history data that indicates the ejection malfunction nozzles may be stored together into the storage device 73.

As mentioned, nozzles as targets of the correction process are set in the ejection malfunction nozzle data (setting data 73a).

### (b) Behavior for Printing

When receiving a print request, the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this process, the correction processing unit 84 reads the setting data 73a from the storage device 73 and determines an ejection malfunction nozzle before starting the printing; and upon detecting a position of a print sheet using the line sensor 31, (a) determines a nozzle corresponding to each pixel in the aforementioned image, (b) determines correction target nozzles used for the aforementioned image, and (c) performs the correction process for the correction target nozzles. Consequently, in this image, the correction process is performed for a part corresponding to the correction target nozzles (and adjacent nozzles in the primary scanning direction to the ejection malfunction nozzle). Subsequently, the control unit 81 performs the aforementioned printing on the basis of the image data after the correction process.

### (c) Behavior for Continuous Printing

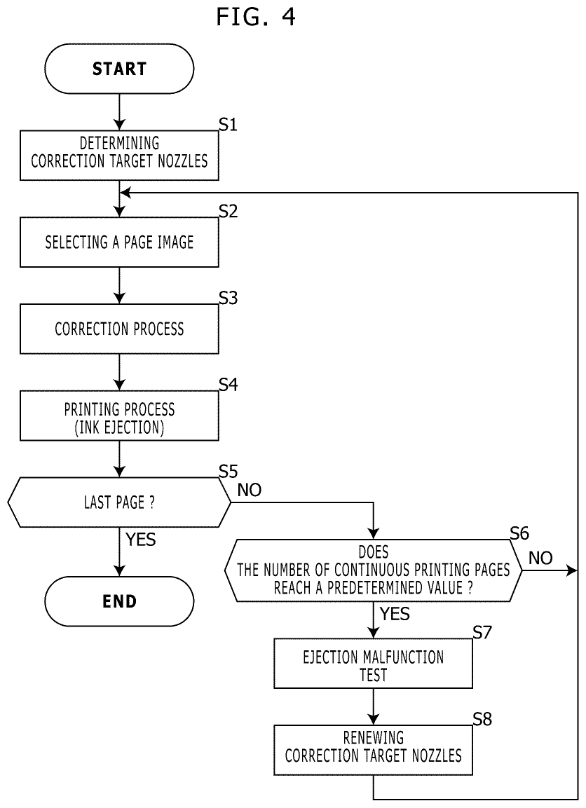

FIG. 4 shows a flowchart that explains a behavior in continuous printing of the image forming apparatus shown in FIGS. 1 to 3. For example, if the number of pages of continuous printing is equal to or larger than the predetermined value, the following process is performed.

Upon receiving a print request, firstly, the correction processing unit 84 reads the setting data 73a from the storage device 73 before start of printing and determines correction target nozzles (in Step S1) and thereafter a page image is selected by the control unit 81 (in Step S2), and upon detecting a position of a print sheet by the line sensor 31, the correction processing unit 84 performs a correction process as mentioned (in Step S3). Subsequently, the control unit 81 causes the print engine 10a to perform a printing process based on the page image after the correction process (in Step S4).

The control unit 81 determines whether printing until the last page has been finished or not (in Step S5). If it is determined that printing until the last page has been finished, the control unit 81 terminates the continuous printing.

Contrarily, if it is determined that printing until the last page has not been finished, the ejection malfunction nozzle detecting unit 83 determines whether or not the number of continuous printing pages from start of the continuous printing or from the previous ejection malfunction test reaches the aforementioned predetermined number of pages (in Step S6).

If it is determined that the number of the continuous printing pages does not reach the aforementioned predetermined number of pages, then returning to Step S2, for the next page, the process in Step S2 and subsequent processes are performed.

Contrarily, it is determined that the number of the continuous printing pages reaches the aforementioned predetermined number of pages, the ejection malfunction nozzle detecting unit 83 suspends the continuous printing, performs an ejection malfunction test as mentioned (in Step S7), and renews correction target nozzles (setting data 73a) (in Step S8). Afterward, the continuous printing is resumed, and returning to Step S2, for the next page, the process in Step S2 and subsequent processes are performed.

As mentioned, in the aforementioned embodiment, the recording head 1a, 1b, 1c or 1d ejects ink corresponding to an image to be printed, using arranged nozzles. The control unit 81 determines nozzles corresponding to the image to be printed and causes the recording head 1a, 1b, 1c or 1d to eject ink from the nozzles. The ejection malfunction nozzle detecting unit 83 performs an ejection malfunction test for the nozzles and detects an ejection malfunction nozzle. The correction processing unit 84 performs a correction process corresponding to the detected ejection malfunction nozzle. Further, in continuous printing, the ejection malfunction nozzle detecting unit 83 performs the ejection malfunction test without the correction process every printing of a predetermined number of pages, and renews the ejection malfunction nozzle for which the correction process is performed, on the basis of a result of the ejection malfunction test.

Consequently, the correction process is not performed for a nozzle of which ejection malfunction is removed in the middle of the continuous printing, and thereby unnecessary correction process is restrained and favorable print image quality is obtained. In particular, when an upperlimit value is set for a correction target nozzle number, the ejection malfunction nozzles for which the correction process are not performed can be reduced.

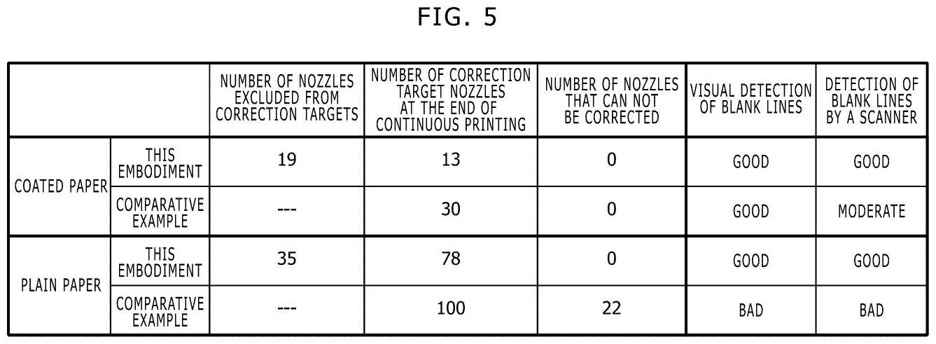

FIG. 5 shows a diagram that explains the number of correction target nozzles in continuous printing of 50,000 pages in the image forming apparatus in an embodiment according to the present disclosure.

In an example shown in FIG. 5, in a condition that 5,000 nozzles are used only for black ink with an output resolution of 1200 dpi, an image forming apparatus according to this embodiment performs the ejection malfunction test and renewal of the correction target nozzles every 10,000 pages; and in case of a coated paper sheet, 19 correction target nozzles among initial continuous target nozzles were excluded in the ejection malfunction test and renewal of the correction target nozzles every 10,000 pages and finally the number of the correction target nozzles became 13. Further, in case of a plain paper sheet, 35 correction target nozzles among initial continuous target nozzles were excluded in the ejection malfunction test and renewal of the correction target nozzles every 10,000 pages and finally the number of the correction target nozzles became 78. A plain paper sheet tends to produce paper dust as a cause of ejection malfunction, compared to a coated paper sheet, and when using a plain paper sheet, ejection malfunction nozzles (i.e. correction target nozzles) tend to increase.

It should be noted in a comparative example, the ejection malfunction test and renewal of the correction target nozzles every 10,000 pages is not performed and initial correction target nozzles remain as correction targets until the end; and in case of a coated paper sheet, there were 30 correction target nozzles. Further, in case of a plain paper sheet, 100 (upperlimit value) correction target nozzles are set among 122 ejection malfunction nozzles, and therefore for 22 ejection malfunction nozzles the correction process was not performed.

In FIG. 5, “VISUAL DETECTION OF BLANK LINES” means whether a blank line on a print product can be visually recognized; “GOOD” means that a blank line is not visually recognized; and “BAD” means a blank line is visually recognized.

Further, in FIG. 5, “DETECTION OF BLANK LINES BY A SCANNER” means whether a blank line is detected in a scanned image of a print product of 1200 dpi; “GOOD” means that a largest value of a difference of RGB values between a normal image and an image after the correction process is less than 10 percent of a normal value; “MODERATE” means that the largest value is equal to or larger than 10 percent and less than 20 percent of a normal value; and “BAD” means that the largest value is equal to or larger than 20 percent.

In an example shown in FIG. 5, this embodiment results in favorable print image quality for any of the print sheet types (“VISUAL DETECTION OF BLANK LINES” is “GOOD” and “DETECTION OF BLANK LINES BY A SCANNER” is “GOOD”). Contrarily, in the comparative example, in case of a plain paper sheet, ejection malfunction nozzles for which the correction process is not performed continuously remain and print image quality is not favorable (“VISUAL DETECTION OF BLANK LINES” is “BAD” and “DETECTION OF BLANK LINES BY A SCANNER” is “BAD”).

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the aforementioned predetermined number of pages may be set corresponding to a type of print sheets to be use for the printing. For example, for a type of paper sheets that produces more paper dust as a cause of ejection malfunction, the aforementioned number of pages is set to be smaller.

Furthermore, in the aforementioned embodiment, the aforementioned predetermined number of pages may be differently set correspondingly to which of duplex printing and simplex printing.

Furthermore, in the aforementioned embodiment, the ejection malfunction test in the middles of the continuous printing may be performed only for nozzles determined as ejection malfunction nozzles in the previous ejection malfunction test.

What is claimed is:

1. An image forming apparatus, comprising:
a recording head configured to eject ink corresponding to an image to be printed, using arranged nozzles;
a control unit configured to determine nozzles corresponding to the image to be printed and cause the recording head to eject ink from the nozzles;
an ejection malfunction nozzle detecting unit configured to perform an ejection malfunction test and thereby detect an ejection malfunction nozzle among the nozzles; and
a correction processing unit configured to perform a correction process corresponding to the detected ejection malfunction nozzle;
wherein in continuous printing, the ejection malfunction nozzle detecting unit performs the ejection malfunction test without the correction process every printing of a predetermined number of pages, and renews the ejection malfunction nozzle for which the correction process is performed, on the basis of a result of the ejection malfunction test.

2. The image forming apparatus according to claim 1, wherein in the ejection malfunction test, the ejection malfunction nozzle detecting unit (a) prints a test pattern on a print sheet using the recording head, and (b) detects the ejection malfunction nozzle on the basis of a density distribution of a scanned image of the test pattern; and
in continuous printing, the ejection malfunction nozzle detecting unit prints the test pattern and performs the ejection malfunction test without the correction process every printing of a predetermined number of pages, and renews the ejection malfunction nozzle for which the correction process is performed, on the basis of a result of the ejection malfunction test.

3. The image forming apparatus according to claim 1, wherein in the ejection malfunction test performed every printing of a predetermined number of pages, on the basis of a result of the current ejection malfunction test, the ejection malfunction nozzle detecting unit sets both of the ejection malfunction nozzle for which the correction process is performed and the ejection malfunction nozzle for which the correction process is not performed.

4. The image forming apparatus according to claim 1, wherein a number of the ejection malfunction nozzles for which the correction process is performed are limited to be equal to or less than a predetermined upperlimit number; and
(a) if a number of the ejection malfunction nozzles detected in the current ejection malfunction test does not exceed the predetermined upperlimit number, the correction processing unit sets both of the ejection malfunction nozzle for which the correction process is performed and the ejection malfunction nozzle for which the correction process is not performed, on the basis of a result of the current ejection malfunction test, and (b) if a number of the ejection malfunction nozzles detected in the current ejection malfunction test exceeds the predetermined upperlimit number, the correction processing unit sets the ejection malfunction nozzle for which the correction process is performed, on the basis of a result of the previous ejection malfunction test and a result of the current ejection malfunction test.
